(19) United States
(12) Patent Application Publication
(10) Pub. No.: US 2018/0374044 A1
(43) Pub. Date: Dec. 27, 2018

(54) SYSTEMS AND METHODS TO TRACK COMMERCIAL PRODUCT SLOTTING EVENTS AT WAREHOUSES

(71) Applicant: Walmart Apollo, LLC, Bentonville, AR (US)

(72) Inventors: Greg A. Bryan, Centerton, AR (US); Todd D. Mattingly, Bentonville, AR (US); Benjamin D. Enssle, Bella Vista, AR (US); Cristy C. Brooks, Cassville, MO (US); David C. Winkle, Bella Vista, AR (US); Bruce W. Wilkinson, Rogers, AR (US)

(21) Appl. No.: 16/011,924

(22) Filed: Jun. 19, 2018

Related U.S. Application Data
(60) Provisional application No. 62/523,158, filed on Jun. 21, 2017.

(51) Int. Cl. G06Q 10/08; H04N 7/18

(52) U.S. Cl. CPC G06Q 10/0875; H04N 7/188

(57) ABSTRACT

In some embodiments, system and methods are provided herein useful to assess commercial product slotting events. In some embodiments, systems are provided to assess commercial product slotting events, and comprises: warehouse slots each configured to hold commercial products to be sold, a first identifier positioned proximate to each warehouse slot, and sensors positioned proximate to the slot and configured to communicate sensor data to control circuits. The control circuits use a sensor to captured images of a second identifier positioned on a commercial product when the commercial product undergoes a positional event. The control circuits can use sensor data to confirm an association between the first identifier and the second identifier. The one or more control circuits generate a notification of the positional event, wherein the positional event is either the placement of the commercial product in the slot or the removal of the commercial product from the slot.

### CROSS-REFERENCE TO RELATED APPLICATION

This application claims the benefit of U.S. Provisional Application No. 62/523,158, filed Jun. 21, 2017, which is incorporated herein by reference in its entirety.

### TECHNICAL FIELD

This invention relates generally to warehouse slot management.

### BACKGROUND

Slotting can refer to the process of organizing the physical positioning of commercial products within a warehouse or distribution center (e.g., to facilitate order picking). At such facilities, commercial products can be assigned to particular slots (i.e. physical storage locations) located throughout the facility in a manner to optimize the efficiency of warehouse operations (e.g., order picking, put away, and replenishment labor functions). Slotting may be conducted in a random or fixed manner. Random slotting implies that items are not assigned to fixed pick locations, rather they are assigned to zones/regions of many pick locations. Fixed slotting implies that items are assigned to fixed bin locations for picking purposes.

### BRIEF DESCRIPTION OF THE DRAWINGS

Disclosed herein are embodiments of systems and methods to enable commercial product registration. This description includes drawings, wherein:

FIG. 1 Illustrates a simplified block diagram of a system for tracking commercial product slotting events, in accordance with certain embodiments;

FIG. 2 is a flow chart of an exemplary process of tracking commercial product slotting events, in accordance with several embodiments; and

FIG. 3 illustrates an exemplary system for use in implementing methods, techniques, devices, apparatuses, systems, servers, sources and tracking commercial product slotting events, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, and methods are provided herein useful to enable tracking of commercial product slotting events. The system can comprise one or more databases of information each having identifying information corresponding to one or more warehouse slots located at a warehouse and a plurality of commercial items assigned for temporary storage in the one or more warehouse slots. Each of the warehouse slots can be configured to hold one or more commercial items of the plurality of commercial items. Each warehouse slot can be configured to include one or more first identifiers, first sensors, and second sensors disposed thereto. Each first identifier can be configured to uniquely identify the particular warehouse slot. Each first sensor can be configured to capture one or more images of the warehouse slot. Each second sensor can be configured to collect data regarding the presence of a commercial item at the warehouse slot, where the commercial item can be uniquely identified by one or more second identifiers disposed thereto.

The collected data can include one or more weight values corresponding to the presence of the commercial item at the warehouse slot. Each warehouse slot can also include one or more control circuits each communicatively coupled to the database(s), the first sensor(s), and the second sensor(s). The one or more control circuits can be configured to cause the first sensor(s) to capture the image(s) of the warehouse slot and cause the second sensor(s) to collect the data. The one or more control circuits can also be configured to confirm the presence of the first identifier and the second identifier in the captured image(s), where the first image and the second image included in the captured image(s) have a threshold number of visual relationships with the first identifier(s) and the second identifier(s), respectively. The one or more control circuits can also be configured to use the first identifier, the second identifier, and the collected data to confirm that the identifying information dictates that the commercial item is included in the plurality of commercial items assigned for temporary storage in the warehouse slot. The one or more control circuits can also be configured to generate one or more notifications having information corresponding to the confirmation.

In some embodiments, methods are provided for enabling tracking of commercial items slotting events at a warehouse. Some of these methods cause one or more first sensors to capture one or more images of a particular warehouse slot that includes one or more first identifiers disposed thereto and uniquely identifying the warehouse slot. The warehouse slot located at warehouse and is configured to hold a plurality of commercial items. One or more second sensors can be caused to capture data regarding the presence of a particular commercial item at the warehouse slot, where the commercial item can be uniquely identified by one or more second identifiers disposed thereto. The collected data can include one or more weight values each corresponding to the presence of the commercial item at the warehouse slot.

The presence of the first identifier(s) and the second identifier(s) in the captured image(s) can be confirmed by identifying one or more first images and one or more second images included in the captured image(s) having a threshold amount of visual relationships with the first identifier(s) and the second identifier(s), respectively. The first identifier(s), the second identifier(s), and the collected data can be used to confirm that identifying information dictates that the commercial item is included in the plurality of commercial items assigned for temporary storage in the warehouse slot. The identifying information can be stored in one or more databases of information having identifying information that corresponds to the warehouse slot located at the warehouse and a plurality commercial items assigned for temporary storage in the warehouse slot. One or more notifications that include information corresponding to the confirmation can be generated.

Slotting can refer to the process of organizing the physical positioning of commercial products within a warehouse or distribution center (e.g., to facilitate order picking). At such facilities, commercial products can be assigned to particular slots (i.e. physical storage locations) located throughout the facility in a manner to optimize the efficiency of warehouse opening (e.g., order picking, put away, and replenishment labor functions). Slotting may be conducted in a random or fixed manner. Random slotting implies that items are not assigned to fixed pick locations, rather they are assigned to zones/regions of many pick locations. Fixed slotting implies that items are assigned to fixed bin locations for picking purposes.

Embodiments disclosed herein may be implemented at one or more warehouses, distribution centers, similar facilities where commercial items are stored, or a combination thereof. As used herein, a “warehouse” can refer to structures (e.g., commercial buildings) configured to store commercial items. As used herein, a “distribution center” can refer to a warehouse stacked with commercial items to be redistributed (e.g., to retailers, wholesalers, consumers, or a combination of two or more thereof). Such structures can include one or more loading docks to facilitate the loading and/or unloading of commercial items from commercial vehicles (e.g., manned vehicles, semi-autonomous vehicles, autonomous vehicles, or a combination thereof). By one approach, a warehouse can be configured to have one or more receiving areas, shipping areas, order picking areas, order assembly areas, storage areas, similar commercial warehouse areas, or a combination of two or more thereof

By one approach, warehouses may employ one or more types of commercial item storage systems (e.g., pallet racking, carton flow modules, mezzanine, vertical lift modules, horizontal carousels, vertical carousels, etc.). For example, commercial items may be stored on a flat transport structure (e.g., a pallet or skid) that supports the items in a stable fashion during transportation (e.g., via a forklift, pallet jack, front loader, work saver, or similar means). Additionally or alternatively, commercial items may be stored in a carton or box. In some embodiments, commercial items received at a warehouse are typically stored in one or more particular “slots,” which are physical storage locations within the warehouse and configured to temporarily receive retail products. As such, the placement of inventory can influence operational efficiency of warehouse or distribution center management.

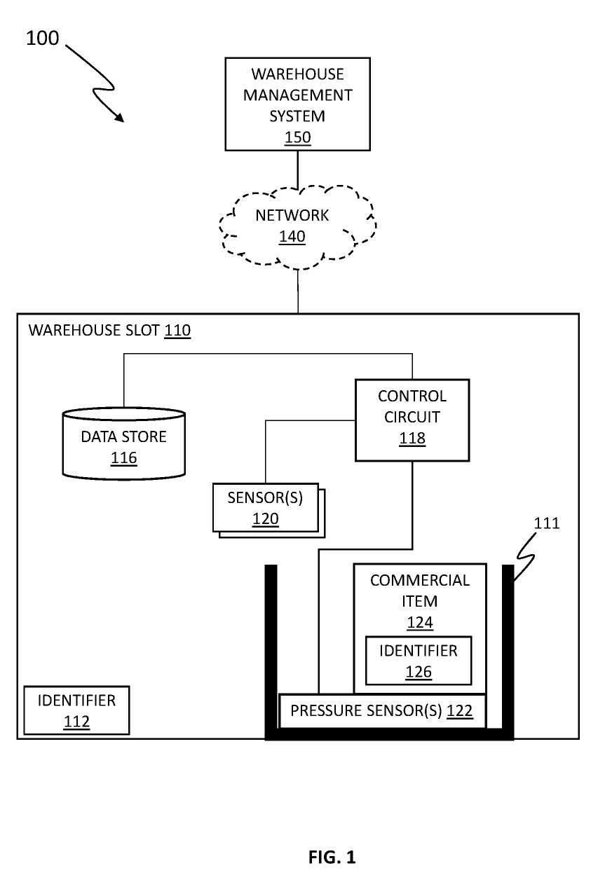

FIG. 1 illustrates a simplified block diagram of a system 100 to enable tracking of commercial item slotting events at a warehouse, in accordance with some embodiments. System 100 may comprise hundreds, and typically thousands or tens of thousands of warehouse slots (“slots”) 110 and one or more warehouse management systems 150 configured to communicate over a computer and/or one or more communication networks (“network”) 140. Network 140 can be, for example, a local area network (LAN), a wide area network (WAN) such as the Internet, or a combination of the two, and includes wired, wireless, and/or fiber optic connections. In general, network 140 can be any combination of connections and protocols that can support communications between the warehouse slots 110 and the one or more warehouse management systems 150, in accordance with some embodiments.

In some embodiments, warehouse management system 150 can be configured to include one or more systems, control circuits, hardware and/or software components that support at least one activity and/or operation of a warehouse or a distribution center (e.g., tracking inventory levels, stock locations, slotting events, order picking events, similar warehouse activities, or a combination of two or more thereof). In some embodiments, warehouse management system 150 can be configured as a standalone system that can include one or more desktop computers, laptop computers, thin clients, servers, wearable computing devices, mobile devices (e.g., smart phones, phablets, tablets, and similar devices), similar electronic user devices, or a combination of two or more thereof that can execute at least one of the computer instructions of the software components. In other implementations, the warehouse management system 150 is implemented through multiple systems, which may be geographically distributed and provide management over one or more warehouse locations. The warehouse management system 150, in some applications, includes one or more: management control circuits; inventory systems that tracks current and/or historic inventory at the warehouse; product distribution management systems that utilizes received orders for products in defining how and when products are distributed from the warehouse; product organization management systems that utilizes a warehouse mapping of thousands of different warehouse slots at the warehouse, tracks occupied and available warehouse slots based on sensor data, tracks expected and received products at the warehouse, and defines product routing and placement within the available warehouse slots of these products being received; data stores and/or databases; and other such management systems. By one approach, effective slotting can improve the placement of inventory, which can reduce picking time, improve service levels, adjust for seasons or nonseasonal demand fluctuations and maximize warehouse space. By one approach, commercial items received and stored at the warehouse can be tracked by associating each commercial item or plurality of items with unique identifying information.

By one approach, warehouse management system 150 can assign unique identifying information (e.g., information corresponding to identifier images, weight values, overall dimensions, assigned slot locations/identifier images, similar identifying data, or a combination of two or more thereof) to one or more commercial items received at the warehouse that includes the multiple distinct slots 110. Alternatively or additionally, identifying information can be received from one or more external data sources and/or generated via one or more input devices (e.g., keyboards, mice, microphones, touchscreens, similar input devices, or a combination of two or more thereof) that may be communicatively coupled to the network 140.

In some embodiments, each of the slots 110 can be a structure configured to receive one or more commercial items 124 for temporary storage at one or more storage structures 111. In some embodiments, the commercial item 124 may be an “each” or a plurality of eaches stored and/or cooperated in a box, carton, shipping container, skid, pallet, or similar storage structures. For example, an “each” can be a single retail item intended to be shipped to a retail location to be made available for purchase by a customer, such as a single bicycle, a single barbeque, a single television, etc. By one approach, and “each” is the base unit of any retail product's packaging (e.g., the actual consumer unit that is scanned and stocked on store shelves). In some embodiments, at least some of the slots 110 each include and/or are associated with one or more data stores 116, sensors 120, and pressure sensors 122 each communicatively coupled to one or more slot control circuits 118. By one approach, the one or more control circuits 118 can be configured (for example, by using corresponding programming as will be well understood by those skilled in the art) to carry out one or more of the steps, actions, and/or functions described herein. In some embodiments, the one or more control circuits 118 can be configured to process video, images, and sensor data to facilitate the one or more of the steps, actions, and/or functions described herein. The sensors 120 may be cooperated with the slot, and/or may be positioned proximate to the slot and oriented to capture relevant data associated with at least that slot. In some implementations, the data stores 116 and/or the control circuit 118 may be associated with two or more slots. In some embodiments, each of the data store 116 can be an information repository that may include files 114, instructions to invoke one or more embodiments described herein, identifying information received from one or more of the warehouse management systems 150 or one or more of external data sources, data captured via the sensors 120, data captured via the pressure sensors 122, historic data, captured data, received data, sensor data, threshold data, and/or other such information. In some embodiments, information of the data store 116 (e.g., identifying information received from one or more of the warehouse management systems 150 or one or more of external data sources, data captured via the sensors 120, data captured via the pressure sensors 122, historic data, captured data, received data, sensor data, threshold data, and/or other such information) can be stored in a lookup table.

Some or all of the information of data store 116 can be accessible by the one or more control circuits 118 and/or can be communicated via a wired and/or wireless transceiver of the warehouse slot 110. In some embodiments, commercial products (e.g., the commercial item 124) received at the warehouse can be stored in one or more particular slots (e.g., warehouse slot 110). In some embodiments, the commercial item 124 and the warehouse slot 110 can each be configured to include one or more unique identifier images (e.g., identifier 124 and identifier 112, respectively) affixed proximate to one or more surfaces thereof. By one approach, each unique identifier image can depict visual information that can be captured by one or more of the sensors 120, converted to machine-readable code, and compared to identifying information of the one or more of the data stores 116 for identification purposes (discussed further below).

In some embodiments, identifier images (e.g., the identifiers 112 and 126) can be a unique string of visual symbols utilized to identify the particular object to which they are affixed and can include one or more barcodes, serial numbers, character strings, similar symbols, or a combination of two or more thereof. In some embodiments, identifier images can include one or more letters, numbers, symbols, pictures, emojis, ideograms, pictograms, ASCII characters, similar characters, or a combination of two or more thereof. By one approach, identifier images may be formed using one or more inks and/or paints detectable via visible light, UV light, heat, chemical reaction, similar detecting methodologies, or a combination of two or more thereof. In some embodiments, one or more sensors 120 can be positioned proximate to one or more surfaces of the warehouse slot 110 and configured to capture one or more images that may include the identifiers 112 and/or the contents of the storage structure 111.

In some embodiments, one or more of the sensors 120 can be configured to one or more capture motion events (e.g., via heat, radio waves, video camera software, light or optical interference, similar techniques, or a combination of two or more thereof) that occur at storage structure 111; and/or one or more images and/or video (e.g., regular, thermal, UV, similar spectrums, or a combination of two or more thereof) of the warehouse slot 110 and the contents of the storage structure 111. In some embodiments, the one or more pressure sensors 122 can be configured to be affixed proximate to one or more weight-bearing surfaces of the storage structure 111 and capture the weight value or pressure data corresponding to the weight of the contents the storage structure 111.

For example, data captured by the sensors 120 and the pressure sensors 122 can be referred to as “captured data,” as opposed to identifying information received via warehouse management system 150 or an external data source (i.e., “received data”). By one approach, management system 150 can be configured to transmit the received data to the data store 116 at a predetermined time period (e.g., a threshold number of seconds, minutes, or hours). In some embodiments, the one or more pressure sensors 122 can be configured to capture the one or more weight values when a motion event is captured by the one or more sensors 120 and/or at a predetermined time period (e.g., a threshold number of seconds, minutes, or hours) to monitor the contents of storage structure 111. In some embodiments, motions events can be used as trigger events to identify the receipt of one or more commercial items at the storage structure 111, the removal of one or more commercial items from the storage structure 111, or a combination of the two. In some embodiments, one or more of the sensors 120 can be configured to capture one or more images of the identifiers 112 and/or the identifiers 126 when a motion event is captured.

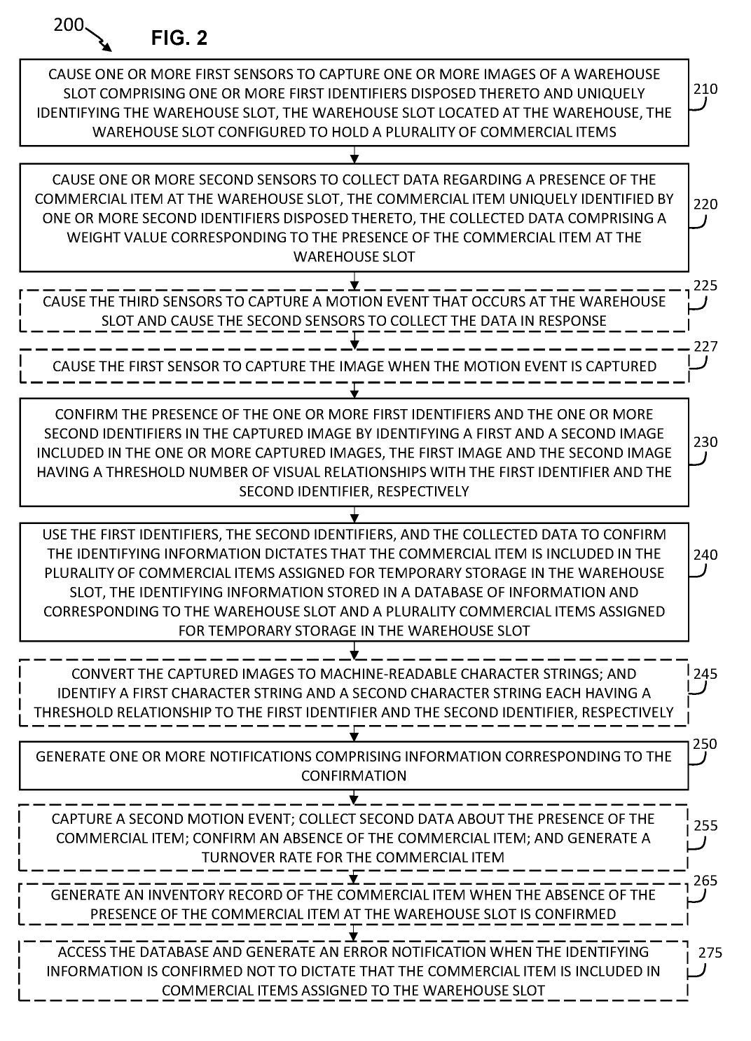

FIG. 2 is a flowchart of an exemplary process, in accordance with some embodiments. One or more first sensors (e.g., sensors 120) can be caused to capture one or more images of the warehouse slot 110 at block 210. For example, the warehouse slot 110 may include one or more first identifiers (e.g., the identifiers 112) disposed thereto and uniquely identifying the warehouse slot 110. The warehouse slot 110 can located at a warehouse and configured to hold a plurality of commercial items (e.g., the commercial item 124). In some embodiments, the one or more captured images can be stored in the data store 116. One or more second sensors (e.g., the pressure sensors 122) can be caused to capture data regarding the presence of one of the plurality of commercial items at the warehouse slot 110 at block 220. For example, the one or more pressure sensors 122 can be affixed to one or more weight-bearing surfaces of the storage structure 111 and caused to capture weight data corresponding to the contents thereof. The commercial item can be uniquely identified by one or more second identifiers (e.g., identifier 126) disposed thereto. The captured data can include one or more weight values corresponding to the presence of the commercial item at the warehouse slot 110. In some embodiments, the one or more captured weight values can be stored in the data store 116. In some embodiments, one or more third sensors (e.g., one or more sensors 120) can be caused to capture one or more motion events that occur at the warehouse slot 110 at block 225. When the sensors 120 captures the one or more motion events, at least one of the second sensors can be caused to capture the weight data.

In some embodiments, at block 227, one or more of the first sensors can be caused to capture the one or more images when the one or more motion events are captured. The presence of the first identifiers and the second identifiers in the captured images can be confirmed at block 230 by identifying one or more first images and one or more second images, respectively, included in the one or more captured image. Each of the first images can have a threshold amount of visual relationships with the first identifier and each of the second images can have a threshold amount of visual relationships with the second identifier. For example, visual symbols included in each of the captured first images and second images can be compared to the received data of the data store 116 to confirm that the first images and second images include visual symbols having a threshold relationship to the first identifier and the second identifier, respectively. The first identifiers, the second identifiers, and the captured weight data can be used to confirm that the identifying information dictates that the commercial item is included in the plurality of commercial items assigned for temporary storage in the warehouse slot 110 at block 240. For example, the identifying information dictates that the commercial item is included in the plurality of commercial items assigned for temporary storage in the warehouse slot 110 when the identifying information reflects a relationship between the first identifiers, the second identifiers, and the captured weight data. The identifying information can be stored in one or more databases of information (e.g., the data store 116, shared data store(s), data store(s) of the warehouse management system 150, etc.) that may each comprise identifying information that corresponds to the warehouse slot 110 and one or more commercial items assigned for temporary storage in the warehouse slot 110. By one approach, the captured weight value can be compared to the previous captured weight value stored in the data store (e.g., the data store 116, shared data store(s), data store(s) of the warehouse management system 150, etc.) to identify the weight value of the commercial item 124 (“identified weight value”). For example, the information of the data store 116 corresponding to the received data can be assessed to identify therein the presence of a relationship between the first identifier, the second identifier, and the identified weight value, the presence of which can confirm the proper slotting of the commercial item 124 at the warehouse slot 110.

Alternatively, in some embodiments, the data store 116 can be assessed to identify in the received data the presence therein of a relationship between the first identifier and the second identifier (“first identification”), which can confirm the proper slotting of the commercial item 124 at the warehouse slot 110. Additional, the identified weight value of the commercial item 124 can be utilized to confirm the correct labeling of the commercial item 124 and/or the unmolested receipt of the commercial item 124. For example, the information of the data store 116 corresponding to the received data can be assessed to identify therein a relationship between the second identifier and the identified weight value (“second identification”), the presence of which can verify the correct labeling of the commercial item 124 and/or the unmolested receipt of the commercial item 124 at the warehouse slot 110 (e.g., that one or more of the components/eaches of the commercial item 124 have not been removed from the commercial item 124, damaged, leaking, etc.). In some embodiments, one or more second identifications can be generated at one or more threshold time periods (e.g., per hour, per work shift, per day, week, month, etc.) to monitor the contents of the warehouse slot 110.

At block 245, the one or more captured images can be converted to a plurality of machine-readable character strings, where one or more first character strings and one or more second character strings each included in the plurality of machine-readable character strings can be evaluated to identify that they have a threshold relationship to the first identifier and the second identifier, respectively. For example, the visual symbols of the one or more captured images of the data store 116 can be converted to a plurality of machine-readable character strings. One or more first character strings and one or more second character strings each included in the plurality of machine-readable character strings can be compared to the received data of the data store 116 to confirm at least one of the first character strings and at least one of the second character strings have a threshold relationship to the first identifier and the second identifier, respectively. One or more notifications having information that corresponds to the confirmation can be generated at block 250. The one or more notifications can include information corresponding to one or more of the identification of warehouse slot 110, the identification of the commercial item 124, a date/time stamp, the first captured image, the second captured image, the captured weight value, similar information, or a combination of two or more thereof. For example, the results of confirmation assessments can be included in generated notifications and transmitted to user electronic devices, central control circuits, similar devices, or a combination of two or more thereof for further examination and/or storage. For example, notifications can be transmitted to alert responsible parties and/or systems of confirmation assessment results, initiate rectification of the error, facilitate reductions in warehouse handling costs, facilitate picking efficiency, or a combination of two or more thereof. At block 255, the one or more third sensors can be caused to capture one or more second motion events that occur at the warehouse slot 110, the one or more second sensors can be caused to capture second data (e.g., second weight data) regarding the presence of the commercial item 124 at the warehouse slot 110 when the second motion event is captured, compare the data to the second data to confirm an absence of the presence of the commercial item at the warehouse slot 110, and a turnover rate for the commercial item 124 can be generated when the absence of the presence of the commercial item 124 at the warehouse slot 110 is confirmed.

For example, additional weight data can subsequently be captured by the one or more pressure sensors 122 and compared to historic captured weight values of the storage structure 111 included in the data store 116 to confirm a weight reduction of the contents of the storage structure 111. The removal of one or more commercial items 124 from the storage structure 111 can be assessed by dividing the reduced weight of the storage structure 111 to the assigned weight of the commercial item 124 included in the data store 116. In some embodiments, a turnover rate can be information that corresponds to a measurement of the number of times one or more of the commercial items 124 is removed from the warehouse slot 110 in a predetermined time period (e.g., one or more days, weeks, months, similar periods of time, or a combination of two or more thereof).

One or more inventory records of the commercial item can be generated at block 265 when the absence of the presence of the commercial item at the warehouse slot is confirmed. For example, when the removal of the one or more commercial items 124 from the storage structure 111 is confirmed, the historic data included in the data store 116 can be assessed to determine the number of commercial items 124 remaining at the storage structure 111 and included in a record that can include one or more of the identifier 112, the identifier 126, and a date/time stamp. At block 275, the database of information comprising the identifying information can be assessed and one or more error notifications can be generated when it is not confirmed that the identifying information dictates that the commercial item 124 is included in the plurality of commercial items assigned for temporary storage in the warehouse slot 110. For example, an error notification can be generated when the identifying information of the data store 116 does not include a relationship between the first identifier, the second identifier, and the captured weight value. By one approach, the generated error notification can be configured to include information identifying one or more of the erroneous commercial item, the warehouse slot 110, a date/time stamp, similar information, or a combination of two or more thereof. In some embodiments, the error notification can include audio information, graphical information, visual information, similar information, or a combination of two or more thereof. Additionally or alternatively, the generated error notification can be transmitted to the warehouse management system 150.

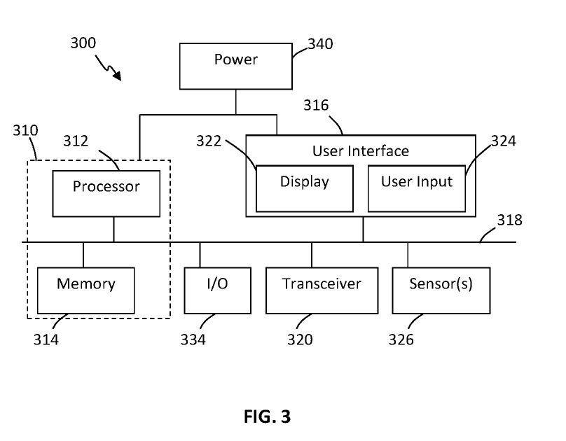

Further, the circuits, circuitry, systems, devices, processes, methods, techniques, functionality, services, servers, sources and the like described herein may be utilized, implemented and/or run on many different types of devices and/or systems. FIG. 3 illustrates an exemplary system 300 that may be used for implementing any of the components, circuits, circuitry, systems, functionality, apparatuses, processes, or devices of the slots 110, the control circuits 118, the warehouse management systems 150, and/or other above or below mentioned systems or devices, or parts of such circuits, circuitry, functionality, systems, apparatuses, processes, or devices. For example, the system 300 may be used to implement some or all of the warehouse slots 110, the control circuits 118, the warehouse management systems 150, one or more other control circuits and/or processing systems of the slots (e.g., video processing systems, image processing systems, sensor data processing systems, emitter system, and the like), one or more control and/or processing systems of the warehouse management systems 150, one or more remote central control systems, and/or other such components, circuitry, functionality and/or devices. However, the use of the system 300 or any portion thereof is certainly not required.

By way of example, the system 300 may comprise a control circuit or processor module 312, memory 314, and one or more communication links, paths, buses or the like 318. Some embodiments may include one or more user interfaces 316, and/or one or more internal and/or external power sources or supplies 340. The control circuit 312 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 312 can be part of control circuitry and/or a control system 310, which may be implemented through one or more processors with access to one or more memory 314 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 300 may be used to implement one or more of the above or below, or parts of, components, circuits, systems, processes and the like.

The user interface 316 can allow a user to interact with the system 300 and receive information through the system. In some instances, the user interface 316 includes a display 322 and/or one or more user inputs 324, such as buttons, touch screen, track ball, keyboard, mouse, etc., which can be part of or wired or wirelessly coupled with the system 300. Typically, the system 300 further includes one or more communication interfaces, ports, transceivers 320 and the like allowing the system 300 to communicate over a communication bus, a distributed computer and/or communication network 140 (e.g., a local area network (LAN), the Internet, wide area network (WAN), etc.), communication link 318, other networks or communication channels with other devices and/or other such communications or combination of two or more of such communication methods. Further the transceiver 320 can be configured for wired, wireless, optical, fiber optical cable, satellite, or other such communication configurations or combinations of two or more of such communications. Some embodiments include one or more input/output (I/O) ports 334 that allow one or more devices to couple with the system 300. The I/O ports can be substantially any relevant port or combinations of ports, such as but not limited to USB, Ethernet, or other such ports. The I/O interface 334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 326 to provide information to the system and/or sensor information that is communicated to another component, such as the central control system, employee computing devices, etc. For example, the sensors 326 may be used to implement some or all of the sensors 120, the pressure sensors 122, or a combination thereof. The sensors can include substantially any relevant sensor, such as distance measurement sensors (e.g., optical units, sound/ultrasound units, etc.), cameras, motion sensors, inertial sensors, accelerometers, impact sensors, pressure sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 300 comprises an example of a control and/or processor-based system with the control circuit 312. Again, the control circuit 312 can be implemented through one or more processors, controllers, central processing units, logic, software and the like. Further, in some implementations the control circuit 312 may provide multiprocessor functionality.

The memory 314, which can be accessed by the control circuit 312, typically includes one or more processor readable and/or computer readable media accessed by at least the control circuit 312, and can include volatile and/or nonvolatile media, such as RAM, ROM, EEPROM, flash memory and/or other memory technology. Further, the memory 314 is shown as internal to the control system 310; however, the memory 314 can be internal, external or a combination of internal and external memory. Similarly, some or all of the memory 314 can be internal, external or a combination of internal and external memory of the control circuit 312. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 140. The memory 314 can store code, software, executables, scripts, data, content, lists, programming, programs, log or history data, user information, customer information, product information, and the like. While FIG. 3 illustrates the various components being coupled together via a bus, it is understood that the various components may actually be coupled to the control circuit and/or one or more other components directly.

In some embodiments, systems are provided to assess commercial product slotting events. Some of the systems can include one or more databases of information each having identifying information corresponding to one or more warehouse slots located at a warehouse and a plurality of commercial items assigned for temporary storage in the one or more warehouse slots. Each of the warehouse slots can be configured to hold one or more commercial items of the plurality of commercial items. Each warehouse slot can be configured to include one or more first identifiers, first sensors, and second sensors disposed thereto. Each first identifier can be configured to uniquely identify the particular warehouse slot. Each first sensor can be configured to capture one or more images of the warehouse slot. Each second sensor can be configured to collect data regarding the presence of a commercial item at the warehouse slot, where the commercial item can be uniquely identified by one or more second identifiers disposed thereto.

The collected data can include one or more weight values corresponding to the presence of the commercial item at the warehouse slot. Each warehouse slot can also include one or more control circuits each communicatively coupled to the database(s), the first sensor(s), and the second sensor(s). The one or more control circuits can be configured to cause the first sensor(s) to capture the image(s) of the warehouse slot and cause the second sensor(s) to collect the data. The one or more control circuits can also be configured to confirm the presence of the first identifier and the second identifier in the captured image(s), where the first image and the second image included in the captured image(s) have a threshold number of visual relationships with the first identifier(s) and the second identifier(s), respectively. The one or more control circuits can also be configured to use the first identifier, the second identifier, and the collected data to confirm that the identifying information dictates that the commercial item is included in the plurality of commercial items assigned for temporary storage in the warehouse slot. The one or more control circuits can also be configured to generate one or more notifications having information corresponding to the confirmation.

In some embodiments, methods are provided for enabling tracking of commercial items slotting events at a warehouse. Some of these methods cause one or more first sensors to capture one or more images of a particular warehouse slot that includes one or more first identifiers disposed thereto and uniquely identifying the warehouse slot. The warehouse slot located at warehouse and is configured to hold a plurality of commercial items. One or more second sensors can be caused to capture data regarding the presence of a particular commercial item at the warehouse slot, where the commercial item can be uniquely identified by one or more second identifiers disposed thereto. The collected data can include one or more weight values each corresponding to the presence of the commercial item at the warehouse slot.

The presence of the first identifier(s) and the second identifier(s) in the captured image(s) can be confirmed by identifying one or more first images and one or more second images included in the captured image(s) having a threshold amount of visual relationships with the first identifier(s) and the second identifier(s), respectively. The first identifier(s), the second identifier(s), and the collected data can be used to confirm that identifying information dictates that the commercial item is included in the plurality of commercial items assigned for temporary storage in the warehouse slot. The identifying information can be stored in one or more databases of information having identifying information that corresponds to the warehouse slot located at the warehouse and a plurality commercial items assigned for temporary storage in the warehouse slot. One or more notifications that include information corresponding to the confirmation can be generated.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to track commercial item slotting events at a warehouse, comprising:
a database of information comprising identifying information corresponding to a warehouse slot located at the warehouse and a plurality of commercial items assigned for temporary storage in the warehouse slot;
the warehouse slot configured to hold a commercial item of the plurality of commercial items and comprising:
a first identifier disposed thereto and uniquely identifying the warehouse slot;
a first sensor disposed thereto and configured to capture an image of the warehouse slot;
a second sensor disposed thereto and configured to collect data regarding a presence of the commercial item at the warehouse slot, the commercial item uniquely identified by a second identifier disposed thereto, the collected data comprising a weight value corresponding to the presence of the commercial item at the warehouse slot; and
a control circuit communicatively coupled to the database, the first sensor, and the second sensor, the control circuit configured to:
cause the first sensor to capture the image of the warehouse slot;
cause the second sensor to collect the data;
confirm the presence of the first identifier and the second identifier in the captured image by identifying a first image and a second image included in the captured image, the first image having a threshold number of visual relationships with the first identifier, the second image having a threshold number of visual relationships with the second identifier;
use the first identifier, the second identifier, and the collected data to confirm that the identifying information dictates that the commercial item is included in the plurality of commercial items assigned for temporary storage in the warehouse slot; and
generate a notification comprising information corresponding to the confirmation.

2. The system of claim 1, wherein
the warehouse slot further comprises a third sensor disposed thereto and configured to capture a motion event that occurs at the warehouse slot; and
the control circuit is configured to cause the second sensor to collect the data when the motion event is captured.

3. The system of claim 2, wherein the control circuit is configured to cause the first sensor to capture the image when the motion event is captured.

4. The system of claim 2, wherein the control circuit is further configured to:
cause the third sensor to capture a second motion event that occurs at the warehouse;
cause the second sensor to collect second data when the second motion event is captured;
compare the data to the second data to confirm an absence of the presence of the commercial item at the warehouse slot; and
generate a turnover rate for the commercial item when the absence of the presence of the commercial item at the warehouse slot is confirmed.

5. The system of claim 2, wherein the control circuit is further configured to generate an inventory record of the commercial item when the absence of the presence of the commercial item at the warehouse slot is confirmed.

6. The system of claim 1, wherein in confirming that the identifying information dictates that the commercial item is included in the plurality of commercial items assigned for temporary storage in the warehouse slot the control circuit is configured to:
convert the captured image to a plurality of machine-readable character strings; and
identify a first character string and a second character string each included in the plurality of machine-readable character strings and having a threshold number of visual relationships to the first identifier and the second identifier, respectively.

7. The system of claim 1, wherein in generating the notification the control circuit is configured to generate an error notification when it is not confirmed that the identifying information dictates that the commercial item is included in the plurality of commercial items assigned for temporary storage in the warehouse slot.

8. A method of tracking commercial item slotting events at a warehouse, comprising:
causing, via a control circuit, a first sensor to capture an image of a warehouse slot, the warehouse slot comprising a first identifier disposed thereto and uniquely identifying the warehouse slot, the warehouse slot located at the warehouse, the warehouse slot configured to hold a plurality of commercial items;
causing, via the control circuit, a second sensor to capture data regarding a presence of the commercial item at the warehouse slot, the commercial item uniquely identified by a second identifier disposed thereto, the collected data comprising a weight value corresponding to the presence of the commercial item at the warehouse slot;
confirming, via the control circuit, the presence of the first identifier and the second identifier in the captured image by identifying a first image and a second image included in the captured image, the first image having a threshold amount of visual relationships with the first identifier, the second image having a threshold amount of visual relationships with the second identifier;
using, via the control circuit, the first identifier, the second identifier, and the collected data to confirm that identifying information dictates that the commercial item is included in the plurality of commercial items assigned for temporary storage in the warehouse slot, the identifying information stored in a database of information comprising identifying information corresponding to the warehouse slot located at the warehouse and a plurality commercial items assigned for temporary storage in the warehouse slot; and
generating, via the control circuit, a notification comprising information corresponding to the confirmation.

9. The method of claim 8, wherein causing the second sensor to capture the data comprises:
causing, via the control circuit, a third sensor to capture a motion event that occurs at the warehouse slot;
causing, via the control circuit, the second sensor to capture the data when the motion event is captured.

10. The method of claim 9, wherein causing the first sensor to capture the image comprises causing, via the control circuit, the first sensor to capture the image when the motion event is captured.

11. The method of claim 9, further comprising:
causing, via the control circuit, the third sensor to capture a second motion event that occurs at the warehouse slot;
causing, via the control circuit, the second sensor to capture second data regarding a presence of the commercial item at the warehouse slot when the second motion event is captured;
comparing, via the control circuit, the data to the second data to confirm an absence of the presence of the commercial item at the warehouse slot; and
generating, via the control circuit, a turnover rate for the commercial item when the absence of the presence of the commercial item at the warehouse slot is confirmed.

12. The method of claim 11, further comprising generating, via the control circuit, an inventory record of the commercial item when the absence of the presence of the commercial item at the warehouse slot is confirmed.

13. The method of claim 8, wherein confirming that the identifying information dictates that the commercial item is included in the plurality of commercial items assigned for temporary storage in the warehouse slot comprises:
converting, via the control circuit, the captured image to a plurality of machine-readable character strings; and
identifying, via the control circuit, a first character string and a second character string each included in the plurality of machine-readable character strings and having a threshold relationship to the first identifier and the second identifier, respectively.

14. The method of claim 8, wherein generating the notification comprises:
accessing, via the control circuit, the database of information comprising the identifying information; and
generating, via the control circuit, an error notification when it is not confirmed that the identifying information dictates that the commercial item is included in the plurality of commercial items assigned for temporary storage in the warehouse slot.
